(19) United States
(12) Patent Application Publication
(10) Pub. No.: US 2018/0220319 A1
(43) Pub. Date: Aug. 2, 2018

(54) METHOD AND DEVICE FOR TERMINAL DETERMINING WHETHER TO REPORT WLAN MEASUREMENT RESULT

(71) Applicant: LG ELECTRONICS INC., Seoul (KR)

(72) Inventor: Sangwon KIM, Seoul (KR)

(73) Assignee: LG ELECTRONICS INC., Seoul (KR)

(21) Appl. No.: 15/747,716

(22) PCT Filed: Aug. 10, 2016
(86) PCT No.: PCT/KR2016/008761

§ 371 Date: Jan. 25, 2018

Related U.S. Application Data
(60) Provisional application No. 62/203,872, filed on Aug. 11, 2015.
(60) Provisional application No. 62/203,874, filed on Aug. 11, 2015.

(51) Int. Cl. H04W 24/10; H04W 88/06; H04W 88/02; H04W 72/04; H04W 28/08

(52) U.S. Cl. CPC H04W 24/10; H04W 88/06; H04W 84/12; H04W 72/0406; H04W 28/08; H04W 88/023

(57) ABSTRACT

Provided are a method for a terminal determining whether to report a wireless local area network (WLAN) measurement result in a wireless communication system, and a device supporting same. A terminal may perform WLAN measurement on an AP included in a serving WLAN AP group, and on the basis of the measured WLAN measurement result, determine whether to report the WLAN measurement result.

### BACKGROUND OF THE INVENTION

### Field of the invention

The present invention relates to a wireless communication system, and more particularly, to a method for determining, by a UE, whether to report a WLAN measurement result in a wireless communication system, and a device supporting the same.

### Related Art

3GPP (3rd Generation Partnership Project) LTE (Long Term Evolution) that is an advancement of UMTS (Universal Mobile Telecommunication System) is being introduced with 3GPP release 8. In 3GPP LTE, OFDMA (orthogonal frequency division multiple access) is used for downlink, and SC-FDMA (single carrier-frequency division multiple access) is used for uplink. The 3GPP LTE adopts MIMO (multiple input multiple output) having maximum four antennas. Recently, a discussion of 3GPP LTE-A (LTE-Advanced) which is the evolution of the 3GPP LTE is in progress.

A wireless communication system may provide a service to a UE through a plurality of access networks. The UE may receive a service from a 3GPP access network such as a mobile wireless communication system. Further, the UE may receive the service from a non-3GPP access network such as WiMAX (Worldwide Interoperability for Microwave Access) or a WLAN (Wireless Local Area Network).

Generally, the UE may establish connection with a 3GPP access network to receive the service. Meanwhile, when traffic overload is generated in a 3GPP access network, if traffic to be processed by the UE is processed by another access network, that is, the non- 3GPP access network, the whole efficiency of the network may be improved. As described above, changeable process of the traffic through the 3GPP access network and/or the non-GPP access network refers to traffic steering so that the traffic is changeably processed through a 3GPP access network and/or a non-GPP access network.

For the traffic steering, a policy for interworking of the 3GPP access network and/or the non-GPP access network such as ANDSF (Access Network Discovery and Selection Functions) may be configured in the UE. The above policy is managed independently from an interworking policy configured by the network.

### SUMMARY OF THE INVENTION

A UE can perform WLAN mobility in an AP group without LTE control and thus may not need to report the WLAN measurement result of an AP belonging to the same group as a currently associated AP to a network. Therefore, in order to prevent the UE from unnecessarily reporting a WLAN measurement result to the network, the UE needs to determine whether to report a WLAN measurement result to the network.

According to one embodiment, there is provided a method for determining, by a UE, whether to report a WLAN measurement result in a wireless communication system. The method may include: performing WLAN measurement on an AP belonging to a serving WLAN AP group; and determining whether to report a WLAN measurement result based on a result of the performed WLAN measurement.

When a value obtained by applying a hysteresis to the WLAN measurement result is less than a threshold, it may be determined to report the WLAN measurement result. The method may further include reporting, by the UE, the WLAN measurement result. The method may further include stopping, by the UE, reporting the WLAN measurement result when a value obtained by applying the hysteresis to the WLAN measurement result is greater than the threshold. The WLAN measurement may be performed on a serving AP among APs belonging to the serving WLAN AP group. The WLAN measurement may be performed on all APs belonging to the serving WLAN AP group.

The method may further include performing, by the UE, WLAN measurement on an AP not belonging to the serving WLAN AP group. When a value obtained by applying a hysteresis to the WLAN measurement result of the AP belonging to the serving WLAN AP group is less than a first threshold and a value obtained by applying the hysteresis to a WLAN measurement result of the AP not belonging to the serving WLAN AP group is greater a second threshold, it may be determined to report the WLAN measurement result. The method may further include reporting, by the UE, the WLAN measurement result. The method may further include stopping, by the UE, reporting the WLAN measurement result when a value obtained by applying the hysteresis to the WLAN measurement result of the AP belonging to the serving WLAN AP group is greater than the first threshold or a value obtained by applying the hysteresis to the WLAN measurement result of the AP not belonging to the serving WLAN AP group is less than the second threshold. The AP belonging to the serving WLAN AP group may be a serving AP serving the UE among APs belonging to the serving WLAN AP group. The AP belonging to the serving WLAN AP group may be all APs belonging to the serving WLAN AP group. The serving WLAN AP group may be a WLAN mobility set.

According to another embodiment, there is provided a UE for determining whether to report a WLAN measurement result in a wireless communication system. The UE may include: a memory; a transceiver; and a processor to connect the memory and the transceiver, wherein the processor may be configured to: perform WLAN measurement on an access point (AP) belonging to a serving WLAN AP group; and determine whether to report a WLAN measurement result based on a result of the performed WLAN measurement

A UE may determine whether to report a WLAN measurement result to a network.

### BRIEF DESCRIPTION OF THE DRAWINGS

FIG. 1 shows LTE system architecture.

FIG. 2 shows a control plane of a radio interface protocol of an LTE system.

FIG. 3 shows a user plane of a radio interface protocol of an LTE system.

FIG. 4 shows a conventional method of performing measurement.

FIG. 5 shows the structure of a wireless local area network (WLAN).

FIG. 6 shows an example of an environment where a 3GPP access network and a WLAN access network coexist.

FIG. 7 shows an example of a legacy ANDSF with respect to an MAPCON.

FIG. 8 shows an example of an enhanced ANDSF with respect to the MAPCON.

FIG. 9 illustrates one example of a method for a UE to determine whether to report a WLAN measurement result according to one embodiment of the present invention.

FIG. 10 is a block diagram illustrating a method for a UE to determine whether to report a WLAN measurement result according to one embodiment of the present invention.

FIG. 11 is a block diagram illustrating a wireless communication system according to the embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802.20, evolved UTRA (E-UTRA), etc. IEEE 802.16m is evolved from IEEE 802.16e, and provides backward compatibility with a system based on the IEEE 802.16e. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

For clarity, the following description will focus on LTE-A. However, technical features of the present invention are not limited thereto.

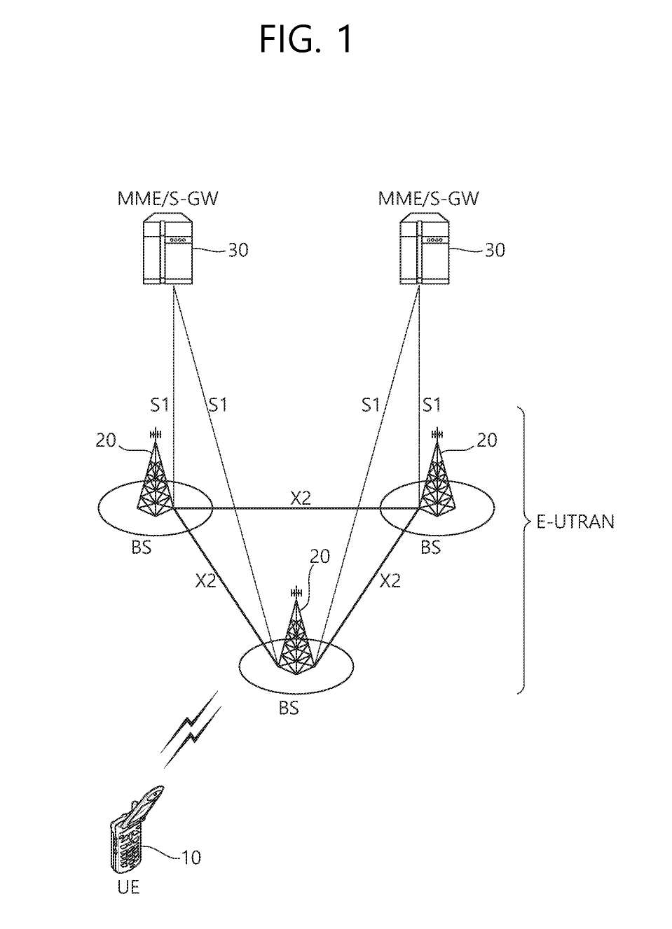

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

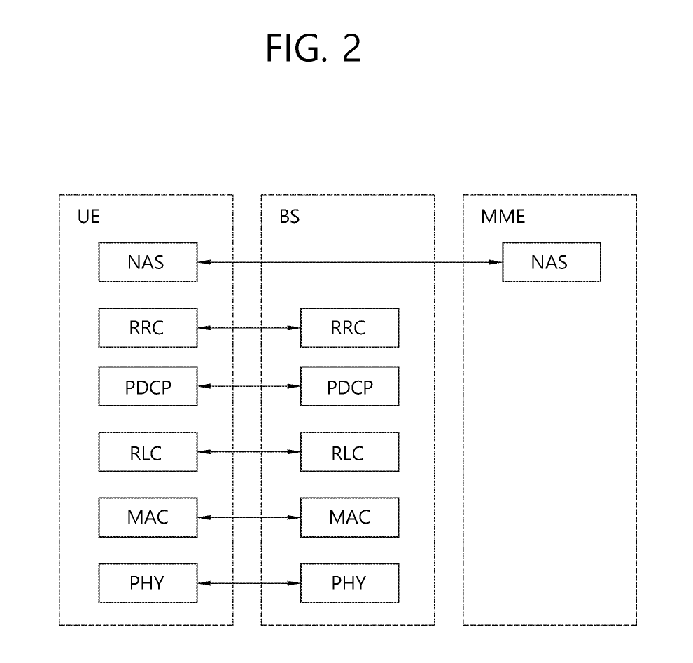

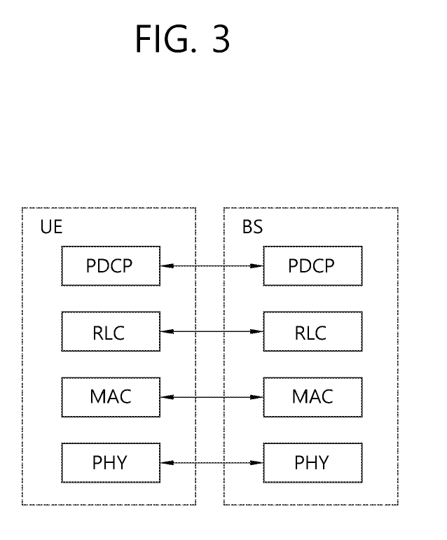

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC_connection with the network. The MCCH is a point-to-multipoint downlink channel used for transmitting MBMS control information from the network to a UE. The DCCH is a point-to-point bi-directional channel used by UEs having an RRC_connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from an upper layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC_layer takes a role of controlling a radio resource between the UE and the network. For this, the UE and the network exchange an RRC_message through the RRC_layer. The RRC_layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC_message in the control plane. The DRB is used as a path for transmitting user data in the user plane.

A Non-Access Stratum (NAS) layer placed over the RRC_layer performs functions, such as session management and mobility management.

Referring to FIG. 2, the RLC and MAC layers (terminated in the eNB on the network side) may perform functions such as scheduling, automatic repeat request (ARQ), and hybrid automatic repeat request (HARQ). The RRC_layer (terminated in the eNB on the network side) may perform functions such as broadcasting, paging, RRC_connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

Referring to FIG. 3, the RLC and MAC layers (terminated in the eNB on the network side) may perform the same functions for the control plane. The PDCP layer (terminated in the eNB on the network side) may perform the user plane functions such as header compression, integrity protection, and ciphering.

Hereinafter, An RRC_state of a UE and RRC_connection procedure are described.

An RRC_state indicates whether an RRC_layer of the UE is logically connected to an RRC_layer of the E-UTRAN. The RRC_state may be divided into two different states such as an RRC_connected state and an RRC_idle state. When an RRC_connection is established between the RRC_layer of the UE and the RRC_layer of the E-UTRAN, the UE is in RRC_CONNECTED, and otherwise the UE is in RRC_IDLE. Since the UE in RRC_CONNECTED has the RRC_connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC_context is stored in the eNB.

In RRC_CONNECTED state, the UE has an E-UTRAN RRC_connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC_connection with the E-UTRAN when uplink data transmission is necessary due to a user's call attempt or the like or when there is a need to transmit a response message upon receiving a paging message from the E-UTRAN.

To manage mobility of the UE in the NAS layer, two states are defined, i.e., an EPS mobility management-REGISTERED (EMM-REGISTERED) state and an EMM-DEREGISTERED state. These two states apply to the UE and the MME. Initially, the UE is in the EMM-DEREGISTERED state. To access a network, the UE performs a process of registering to the network through an initial attach procedure. If the attach procedure is successfully performed, the UE and the MME enter the EMM-REGISTERED state.

To manage a signaling connection between the UE and the EPC, two states are defined, i.e., an EPS connection management (ECM)-IDLE state and an ECM-CONNECTED state. These two states apply to the UE and the MME. When the UE in the ECM-IDLE state establishes an RRC_connection with the E-UTRAN, the UE enters the ECM-CONNECTED state. When the MME in the ECM-IDLE state establishes an S1 connection with the E-UTRAN, the MME enters the ECM-CONNECTED state. When the UE is in the ECM-IDLE state, the E-UTRAN does not have context information of the UE. Therefore, the UE in the ECM-IDLE state performs a UE-based mobility related procedure such as cell selection or reselection without having to receive a command of the network. On the other hand, when the UE is in the ECM-CONNECTED state, mobility of the UE is managed by the command of the network. If a location of the UE in the ECM-IDLE state becomes different from a location known to the network, the UE reports the location of the UE to the network through a tracking area update procedure.

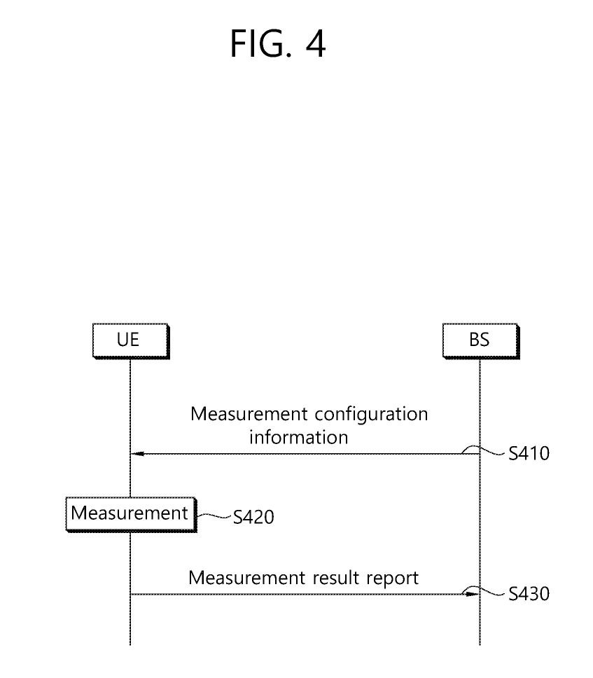

FIG. 4 shows a conventional method of performing measurement.

A UE receives measurement configuration information from a BS (S410). A message including the measurement configuration information is referred to as a measurement configuration message. The UE performs measurement based on the measurement configuration information (S420). If a measurement result satisfies a reporting condition included in the measurement configuration information, the UE reports the measurement result to the BS (S430). A message including the measurement result is referred to as a measurement report message.

The measurement configuration information may include the following information.

(1) Measurement object: The object is on which the UE performs the measurements. The measurement object includes at least one of an intra-frequency measurement object which is an object of intra-frequency measurement, an inter-frequency measurement object which is an object of inter-frequency measurement, and an inter-RAT measurement object which is an object of inter-RAT measurement. For example, the intra-frequency measurement object may indicate a neighboring cell having the same frequency as a frequency of a serving cell, the inter-frequency measurement object may indicate a neighboring cell having a different frequency from a frequency of the serving cell, and the inter-RAT measurement object may indicate a neighboring cell of a different RAT from an RAT of the serving cell.

(2) Reporting configuration: This includes a reporting criterion and a reporting format. The reporting criterion is used to trigger the UE to send a measurement report and can either be periodical or a single event description. The reporting format is a quantity that the UE includes in measurement reporting and associated information (e.g. number of cells to report).

(3) Measurement identify: Each measurement identity links one measurement object with one reporting configuration. By configuring multiple measurement identities, it is possible to link more than one measurement object to the same reporting configuration, as well as to link more than one reporting configuration to the same measurement object. The measurement identity is used as a reference number in measurement reporting. The measurement identify may be included in measurement reporting to indicate a specific measurement object for which the measurement result is obtained and a specific reporting condition according to which measurement reporting is triggered.

(4) Quantity configuration: One quantity configuration is configured per RAT type. The quantity configuration defines the measurement quantities and associated filtering used for all event evaluation and related reporting of that measurement type. One filter can be configured per measurement quantity.

(5) Measurement gaps: Measurement gaps are periods that the UE may use to perform measurements when downlink transmission and uplink transmission are not scheduled.

To perform a measurement procedure, the UE has a measurement object, a reporting configuration, and a measurement identity.

In 3GPP LTE, the BS can assign only one measurement object to the UE with respect to one frequency. Events for triggering measurement reporting are shown in the table 1. If the measurement result of the UE satisfies the determined event, the UE transmits a measurement report message to the BS.

TABLE 1

| Event | Reporting Condition |
|---|---|
| Event A1 | Serving becomes better than threshold |
| Event A2 | Serving becomes worse than threshold |
| Event A3 | Neighboring becomes offset better than PCell/PSCell |
| Event A4 | Neighboring becomes better than threshold |
| Event A5 | PCell/PSCell becomes worse than threshold1 and |
| | neighboring becomes better than threshold2 |
| Event A6 | Neighboring becomes offset better than SCell |
| Event B1 | Inter RAT neighboring becomes better than threshold |
| Event B2 | PCell becomes worse than threshold1 and inter RAT |
| | neighboring becomes better than threshold2 |
| Event C1 | CSI-RS resource becomes better than threshold |
| Event C2 | CSI-RS resource becomes offset better than reference CSI-RS |
| | resource |

The measurement report may include the measurement identity, a measured quality of the serving cell, and a measurement result of the neighboring cell. The measurement identity identifies a measurement object in which the measurement report is triggered. The measurement result of the neighboring cell may include a cell identity and a measurement quality of the neighboring cell. The measured quality may include at least one of reference signal received power (RSRP) and reference signal received quality (RSRQ).

Hereinafter, Event-Triggering Conditions for Measurement Reporting Are Described in Detail.

Ten types of event-triggering conditions are defined for measurement reporting (see Table 1), and each event-triggering condition includes an entering condition and a leaving condition. A UE that satisfies an entering condition of an event from a BS may perform measurement reporting to the BS. When the UE performing measurement reporting satisfies a leaving condition of the event, the UE may stop measurement reporting to the BS. Hereinafter, an entering condition and a leaving condition of each event are illustrated.

1. Event A1 (Serving becomes better than threshold)

(1) Event A1-1 entering condition: Ms−Hys>Thresh

(2) Event A1-2 leaving condition: Ms+Hys<Thresh

2. Event A2 (Serving becomes worse than threshold)

(1) Event A2-1 entering condition: Ms+Hys<Thresh

(2) Event A2-2 leaving condition: Ms−Hys>Thresh

A UE triggers an event based on a measurement result Ms of a serving cell. After applying each parameter, event A1 is triggered when the measurement result Ms of the serving cell is better than the threshold of event A1, while event A2 is triggered when the measurement result Ms of the serving cell is worse than the threshold of event A2.

3. Event A3 (Neighboring becomes offset better than PCell/PSCell)

(1) Event A3-1 entering condition: Mn+Ofn+Ocn−Hys>Mp+Ofp+Ocp+Off

(2) Event A3-2 leaving condition: Mn+Ofn+Ocn+Hys<Mp+Ofp +Ocp+Off

4. Event A4 (Neighboring becomes better than threshold)

(1) Event A4-1 entering condition: Mn+Ofn+Ocn−Hys>Thresh

(2) Event A4-2 leaving condition: Mn+Ofn+Ocn+Hys<Thresh

UE triggers an event based on a measurement result Mp of a serving cell and a measurement result Mn of a neighboring cell. After applying each parameter, event A3 is triggered when the measurement result Mn of the neighboring cell is better than the offset of event A3, while event A4 is triggered when the measurement result Mn of the neighboring cell is better than the threshold of event A4.

5. Event A5 (PCell/PSCell becomes worse than threshold) and neighboring becomes better than threshold2)

(1) Event A5-1 entering condition: Mp+Hys<Thresh1

(2) Event A5-2 entering condition: Mn+Ofn+Ocn−Hys>Thresh2

(3) Event A5-3 leaving condition: Mp−Hys>Thresh1

(4) Event A5-4 leaving condition: Mn+Ofn+Ocn+Hys<Thresh2

A UE triggers an event based on a measurement result Mp of a PCell/PSCell and a measurement result Mn of a neighboring cell. After applying each parameter, event A5 is triggered when the measurement result Mp of the PCell/PSCell is worse than threshold 1 of event A5 and the measurement result Mn of the neighboring cell is better than threshold 2 of event A5.

6. Event A6 (Neighboring becomes offset better than SCell)

(1) Event A6-1 entering condition: Mn+Ocn−Hys>Ms+Ocs+Off

(2) Event A6-2 leaving condition: Mn+Ocn+Hys<Ms+Ocs+Off

A UE triggers an event based on a measurement result Ms of a serving cell and a measurement result Mn of a neighboring cell. After applying each parameter, event A6 is triggered when the measurement result Mn of the neighboring cell is better than the offset of event A6.

7. Event B1 (Inter RAT neighboring becomes better than threshold)

(1) Event B1-1 entering condition: Mn+Ofn−Hys>Thresh

(2) Event B1-2 leaving condition: Mn+Ofn+Hys<Thresh

A UE triggers an event based on a measurement result Mn of a neighboring cell. After applying each parameter, event B1 is triggered when the measurement result Mn of the neighboring cell is better than the threshold of event B1.

8. Event B2 (PCell becomes worse than threshold) and inter RAT neighboring becomes better than threshold2)

(1) Event B2-1 entering condition: Mp+Hys<Thresh1

(2) Event B2-2 entering condition: Mn+Ofn−Hys>Thresh2

(3) Event B2-3 leaving condition: Mp−Hys>Thresh1

(4) Event B2-4 leaving condition: Mn+Ofn+Hys<Thresh2

A UE triggers an event based on a measurement result Mp of a PCell/PSCell and a measurement result Mn of a neighboring cell. After applying each parameter, event B2 is triggered when the measurement result Mp of the PCell/PSCell is worse than threshold 1 of event B2 and the measurement result Mn of the neighboring cell is better than threshold 2 of event B2.

9. Event C1 (CSI-RS resource becomes better than threshold)

(1) Event C1-1 entering condition: Mcr+Ocr−Hys>Thresh

(2) Event C1-2 leaving condition: Mcr+Ocr+Hys<Thresh

A UE triggers an event based on a CSI-RS measurement result Mcr. After applying each parameter, event C1 is triggered when the CSI-RS measurement result Mcr is better than the threshold of event C1.

10. Event C2 (CSI-RS resource becomes offset better than reference CSI-RS resource)

(1) Event C2-1 entering condition: Mcr+Ocr−Hys>Mref+Oref+Off

(2) Event C2-2 leaving condition: Mcr+Ocr+Hys<Mref+Oref+Off

A UE triggers an event based on a CSI-RS measurement result Mcr and a measurement result Mref of a reference CSI-RS resource. After applying each parameter, event C2 is triggered when the measurement result Mref of the reference CSI-RS resource is better than the offset of event C2.

Parameters defined for each event are as follows.

Ms is a measurement result of a serving cell, which does not consider any offset.

Mp is a measurement result of a PCell/PSCell, which does not consider any offset.

Mn is a measurement result of a neighboring cell, which does not consider any offset.

Mcr is a measurement result of a CSI-RS resource, which does not consider any offset.

Hys is a hysteresis parameter for each event (that is, a hysteresis defined in a reporting configuration EUTRA (reportConfigEUTRA) for each event).

Ofn is a frequency-specific offset for a frequency of a neighboring cell (that is, an offset frequency defined in a measurement object EUTRA (measObjectEUTRA) corresponding to a frequency of a neighboring cell).

Ocs is a cell-specific offset for a serving cell (that is, a cell individual offset (cellIndividualOffset) defined in a measurement object EUTRA corresponding to a frequency of a serving cell). If no Ocs is set for a serving cell, the offset is set to 0.

Ocn is a cell-specific offset for a neighboring cell (that is, a cell individual offset defined in a measurement object EUTRA corresponding to a frequency of a neighboring cell). If no Ocn is set for a neighboring cell, the offset is set to 0.

Ofp is a frequency-specific offset for a frequency of a PCell/PSCell (that is, an offset frequency defined in a measurement object EUTRA corresponding to a frequency of a PCell/PSCell).

Ocp is a cell-specific offset for a PCell/PSCell (that is, a cell individual offset defined in a measurement object EUTRA corresponding to a frequency of a PCell/PSCell). If no Ocp is set for a PCell/PSCell, the offset is set to 0.

Ocr is a CSI-RS-specific offset (that is, a CSI-RS individual offset (csi-RS-IndividualOffset) defined in a measurement object EUTRA corresponding to a frequency of a CSI-RS resource). If no Ocr is set for a CSI-RS resource, the offset is set to 0.

Mref is a measurement result of a reference CSI-RS resource (that is, a measurement result of a reference CSI-RS resource defined in a reporting configuration EUTRA for event C2), which does not consider any offset.

Oref is a CSI-RS-specific offset for a reference CSI-RS resource (that is, a CSI-RS individual offset defined in a measurement object EUTRA corresponding to a frequency of a reference CSI-RS resource). If no Oref is set for a CSI-RS resource, the offset is set to 0.

Thresh is a threshold parameter for each event (that is, a threshold defined in a reporting configuration EUTRA for each event). Different threshold parameters may be used respectively for events A1 to C2.

Off is an offset parameter for each event (that is, an offset defined in a reporting configuration EUTRA for each event). Different offset parameters may be used respectively for events A3, A6, and C2.

A BS may report or may not report a serving-cell quality threshold (s-Measure). When the BS reports the quality threshold of a serving cell, a UE performs the measurement of a neighboring cell and the evaluation of an event (determining whether an event-triggering condition is satisfied, also referred to as the evaluation of reporting criteria) when the quality (RSRP) of the serving cell is lower than the quality threshold of the serving cell. When the BS does not report the quality threshold of the serving cell, the UE performs the measurement of the neighboring cell and the evaluation of an event without depending on the quality (RSRP) of serving cell.

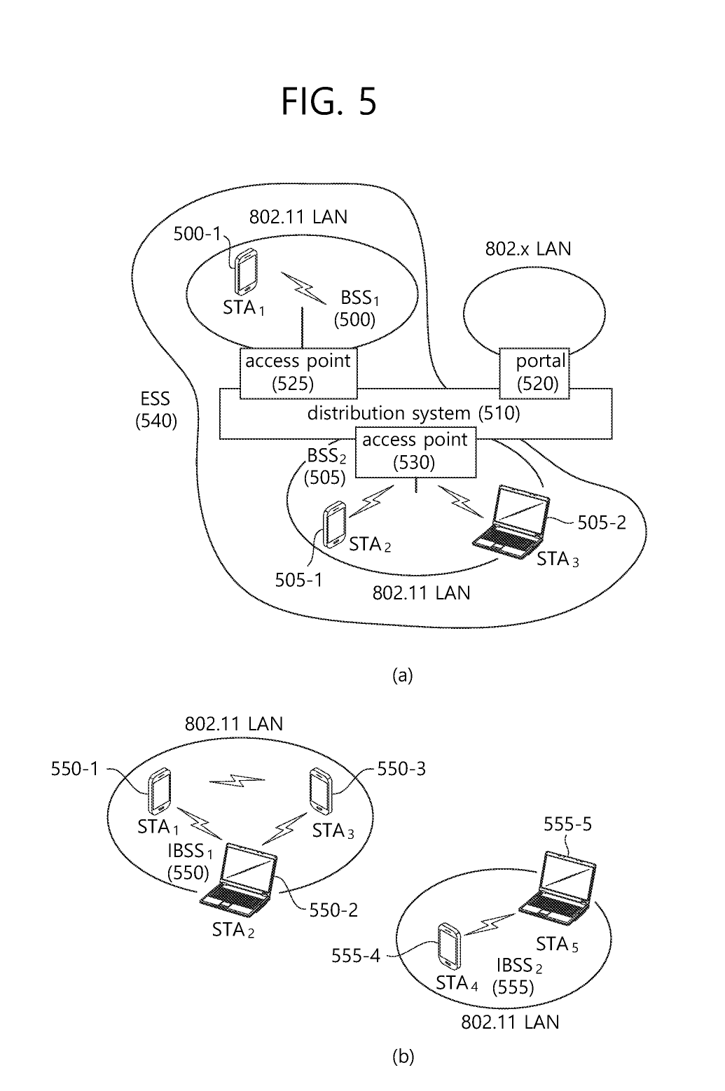

FIG. 5 shows the structure of a wireless local area network (WLAN). FIG. 5(a) shows the structure of an infrastructure network of Institute of Electrical and Electronics Engineers (IEEE) 802.11. FIG. 5(b) shows an independent BSS.

Referring the FIG. 5(a), a WLAN system may include one or more basic service sets (BSSs) 500 and 505. The BSSs 500 and 505 are a set of an access point (AP) and a station (STA), such as an AP 525 and STA1 500-1, which are successfully synchronized to communicate with each other, and are not a concept indicating a specific region. The BSS 505 may include one AP 530 and one or more STAs 505-1 and 505-2 that may be connected to the AP 530.

An infrastructure BSS may include at least one STA, APs 525 and 530 providing a distribution service, and a distribution system (DS) 510 connecting a plurality of APs.

The distribution system 510 may configure an extended service set (ESS) 540 by connecting a plurality of BSSs 500 and 505. The ESS 540 may be used as a term indicating one network configured by connecting one or more APs 525 or 530 through the distribution system 510. APs included in one ESS 540 may have the same service set identification (SSID).

A portal 520 may serve as a bridge that connects the WLAN (IEEE 802.11) and another network (for example, 802.X).

In the infrastructure network illustrated in the FIG. 5(a), a network between the APs 525 and 530 and a network between the APs 525 and 530 and the STAs 500-1, 505-1, and 505-2 may be configured. However, it is possible to configure a network between STAs in the absence of the APs 525 and 530 to perform communication. A network configured between STAs in the absence of the APs 525 and 530 to perform communication is defined as an ad hoc network or independent basic service set (BSS).

Referring to FIG. 5(b), an independent BSS (IBSS) is a BSS that operates in an ad hoc mode. The IBSS includes no AP and thus has no centralized management entity that performs a management function at the center. That is, in the IBSS, STAs 550-1, 550-2, 550-3, 555-4, and 555-5 are managed in a distributed manner. In the IBSS, all STAs 550-1, 550-2, 550-3, 555-4, and 555-5 may be mobile STAs. Further, the STAs are not allowed to access the DS and thus establish a self-contained network.

An STA is a functional medium including medium access control (MAC) and a physical layer interface for a radio medium according to IEEE 802.11 specifications and may be used to broadly mean both an AP and a non-AP STA.

An STA may also be referred to as various names, such as a mobile UE, a wireless device, a wireless transmit/receive unit (WTRU), user equipment (UE), a mobile station (MS), a mobile subscriber unit, or simply a user.

Hereinafter, Interworking Between a 3GPP Access Network and Other Access Network will Be Described.

A 3GPP introduces interworking with a non-3GPP access network (e.g. WLAN) from Rel-8 to find accessible access network, and regulates ANDSF (Access Network Discovery and Selection Functions) for selection. An ANDSF transfers accessible access network finding information (e.g. WLAN, WiMAX location information and the like), Inter-System Mobility Policies (ISMP) capable of reflecting policies of a business, and an Inter-System Routing Policy (ISRP). The UE may determine whether to transmit certain IP traffic through a certain access network. An ISMP may include a network selection rule with respect to selection of one active access network connection (e.g., WLAN or 3GPP) by the UE. An ISRP may include a network selection rule with respect to selection of at least one potential active access network connection (e.g., both of WLAN and 3GPP) by the UE. The ISRP includes Multiple Access PDN Connectivity (MAPCON), IP Flow Mobility (IFOM), and non-seamless WLAN offloading. For dynamic provision between the ANDSF and the UE, Open Mobile Alliance Device Management (OMA DM) or the like are used.

The MAPCON simultaneously configures and maintains a plurality of packet data networks (multiple PDN connectivity) through a 3GPP access network and a non-3GPP access network and regulates a technology capable of performing seamless traffic offloading in the whole active PDN connection unit. To this end, an ANDSF server provides APN (Access Point Name) information to perform offloading, inter-access network priority (routing rule), Time of Day to which offloading method is applied, and access network (Validity Area) information to be offloaded.

The IFOM supports mobility and seamless offloading of an IP flow unit of flexible subdivided unit as compared with the MAPCON. A technical characteristic of the IFOM allows a UE to access through different access network when the UE is connected to a packet data network using an access point name (APN). Mobility and a unit of offloading may be moved in a specific service IP traffic flow unit which is not a packet data network (PDN), the technical characteristic of the IFOM has flexibility of providing a service. To this end, an ANDSF server provides IP flow information to perform offloading, priority (routing rule) between access networks, Time of Day to which an offloading method is applied, and Validity Area where offloading is performed.

The non-seamless WLAN offloading refers to a technology which changes a certain path of a specific IP traffic to a WLAN and completely offloads traffic without passing through an EPC. Since the non-seamless WLAN offloading is not anchored in P-GW for supporting mobility, offloaded IP traffic may not continuously moved to a 3GPP access network. To this end, the ANDSF server provides information similar to information to be provided for performing an IFOM.

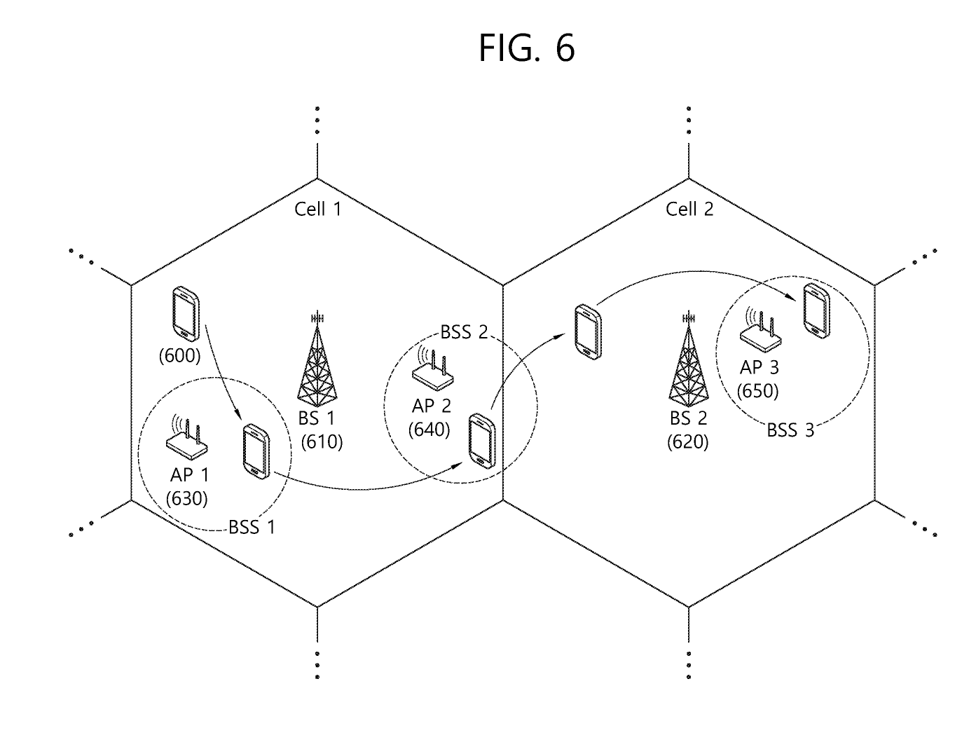

FIG. 6 shows an example of an environment where a 3GPP access network and a WLAN access network coexist.

Referring to FIG. 6, a cell 1 centering a base station 1 (610) and a cell 2 centering a base station 2 (620) are deployed as a 3GPP access network. Further, a Basic Service Set (BSS) 1 as the WLAN access network centering an Access Point (AP) 1 (630) located in a cell 1 and a BSS 2 centering AP 2 (640) and deployed. A BSS 3 centering an AP 3 (650) located in a cell 2 is deployed. Coverage of the cell is shown with a solid line, and coverage of BSS is shown with a dotted line.

It is assumed that the UE 600 is configured to perform communication through a 3GPP access network and a WLAN access network. In this case, the UE 600 may refer to a station.

First, the UE 600 may establish connection with a BS 1 (610) in a cell 1 to perform traffic through a 3GPP access network.

The UE 600 may enters coverage of BSS 1 while moving into coverage of cell 1. In this case, the UE 600 may connect with a WLAN access network by performing association and authentication procedures with an AP1 (630) of BSS1. Accordingly, the UE 600 may process traffic through a 3GPP access network and a WLAN access network. Meanwhile, the UE 600 moves and is separated from the coverage BSS1, connection with a WLAN access network may be terminated.

The UE 600 continuously move into the coverage of cell 1 and move around a boundary between cell 1 and cell 2, and enters coverage of BSS 2 to find BSS 2 through scanning. In this case, the UE 600 may connect with the WLAN access network by performing association and authentication procedures of AP 2 (640) of the BSS 2. Meanwhile, since the UE 600 in the coverage of the BSS 2 is located at a boundary between the cell 1 and the cell 2, service quality through the 3GPP access network may not be excellent. In this case, the UE 600 may operate to mainly process traffic through a WLAN access network.

When the UE 600 moves and is separated from the coverage of the BSS 2 and enters a center of the cell 2, the UE 600 may terminate connection with the WLAN access network and may process traffic through a 3GPP access network based on the cell 2.

The UE 600 may enter coverage of the BSS 3 while moving into the coverage of cell 2 to find the BSS1 through scanning. In this case, the UE 600 may connect with the WLAN access network by association and authentication procedures of an AP3 (650) of the BSS3. Accordingly, the UE 600 may process the traffic through the 3GPP access network and the WLAN access network.

As illustrated in an example of FIG. 6, in a wireless communication environment where a 3GPP access network and a non-3GPP access network coexist, the UE may adaptively process traffic through a 3GPP access network and/or a non-3GPP access network.

As policies for interworking between the 3GPP access network and a non- 3GPP access network, the above ANDSF may be configured. If the ANDSF is configured, the UE may process traffic of the 3GPP access network through a non-3GPP access network or a 3GPP access network.

Meanwhile, interworking policies except for the ANDSF may be configured. In order to easily use the WLAN except for ANDSF in a current 3GPP network, interworking policies reflecting measurement parameters such as load and signal quality of the 3GPP access and/or the WLAN access network are defined. Hereinafter, the policy refers to an RAN policy. Further, a traffic steering rule according to an RAN policy refers to an RAN rule.

The RAN rule may be provided to the UE together with at least one RAN rule parameter for evaluating traffic steering according to the RAN rule. The RAN rule and the RAN rule parameter may be configured as follows.

1. The RAN rule may indicate whether traffic steering to a WLAN is allowed.

2. The RAN rule may indicate a traffic steering estimation condition being a condition allowed or required by traffic steering performing to the WLAN access network from the 3GPP access network. The condition according to the RAN rule may involve estimation of measurement results with respect to an LTE cell. Further, the condition according to the RAN rule may involve estimation of measurement results with respect to the WLAN. The estimation may be comparison of the measurement result with an RAN rule parameter (e.g., a measurement threshold value and the like) indicated in the traffic steering information. The following illustrates an example of a traffic steering estimation condition considered by the UE.

(1) Traffic steering condition to a WLAN access network

RSRP measurement value (measured_RSRP)<low RSRP threshold value (Threshold_RSRP_low)

3GPP load measurement value (measured_3GPPLoad)>high 3GPP load threshold value (Threshold_3GPPLoad_High)

WLAN load measurement value (measured_WLANLoad)<low WLAN load threshold value (Threshold_WLANLoad_low)

WLAN signal strength measurement value (measured WLANsignal)>high WLAN signal strength threshold value (Threshold_WLANsignal_high)

(2) Traffic steering condition to 3GPP access network

RSRP measurement value (measured_RSRP)>high RSRP threshold value (Threshold_RSRP—high)

3GPP load measurement value (measured_3GPPLoad)<low 3GPP load threshold value (Threshold_3GPPLoad_High)

WLAN load measurement value (measured_WLANLoad)>high WLAN load threshold value (Threshold_WLANLoad_high)

WLAN signal strength measurement value (measured_WLANsignal)<low WLAN signal strength threshold value (Threshold_WLANsignal_low)

Meanwhile, the estimation condition may be configured while the at least one condition is coupled with each other using and/or. For example, the traffic steering estimation condition implemented by coupling the at least one condition may be implemented as follows.

Traffic steering estimation condition for traffic steering to WLAN: (measured_RSRP<Threshold_RSRP_low) and (measured_WLANLoad<Threshold_WLANLoad_low) and (measured_WLANsignal>Threshold_WLANsignal_high)

Traffic steering estimation condition for traffic steering to 3GPP: (measured_RSRP>Threshold_RSRP_low) or (measured_WLANLoad>Threshold_WLANLoad_high) or (measured_WLANsignal<Threshold_WLANsignal_low)

3. The RAN rule may indicate a condition where traffic steering performing to a 3GPP access network from the WLAN access network is allowed or required.

4. The RAN rule may indicate an object WLAN access network where performing the traffic steering from the 3GPP access network is allowed or required.

5. The RAN rule may indicate traffic in which routing is allowed to the WLAN access network. Alternatively, the RAN rule may indicate at least one traffic where routing to the WLAN access network is allowed, that is, which may be served by the 3GPP access network.

Meanwhile, the ANDSF configured in the UE may include a legacy ANDSF and/or an enhanced ANDSF.

The legacy ANDSF may be defined as an ANDSF which does not include ANDSF management object (MO) such as corresponding parameters defined in the RAN rule parameter. Unlike the legacy ANDSF, the enhanced ANDSF may be defined as an ANDSF including an ANDSF MO such as corresponding parameters defined in a RAN rule parameter.

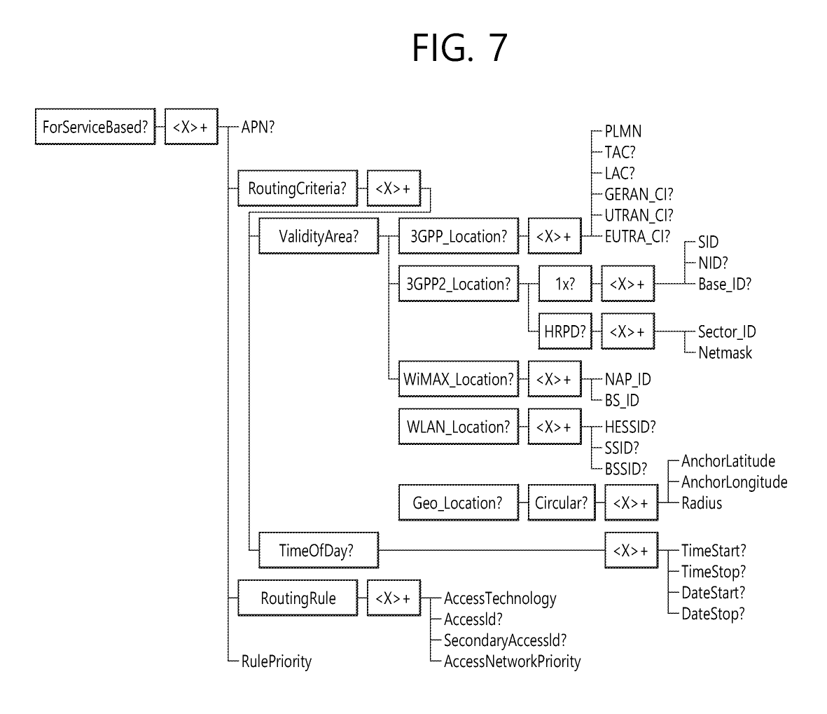

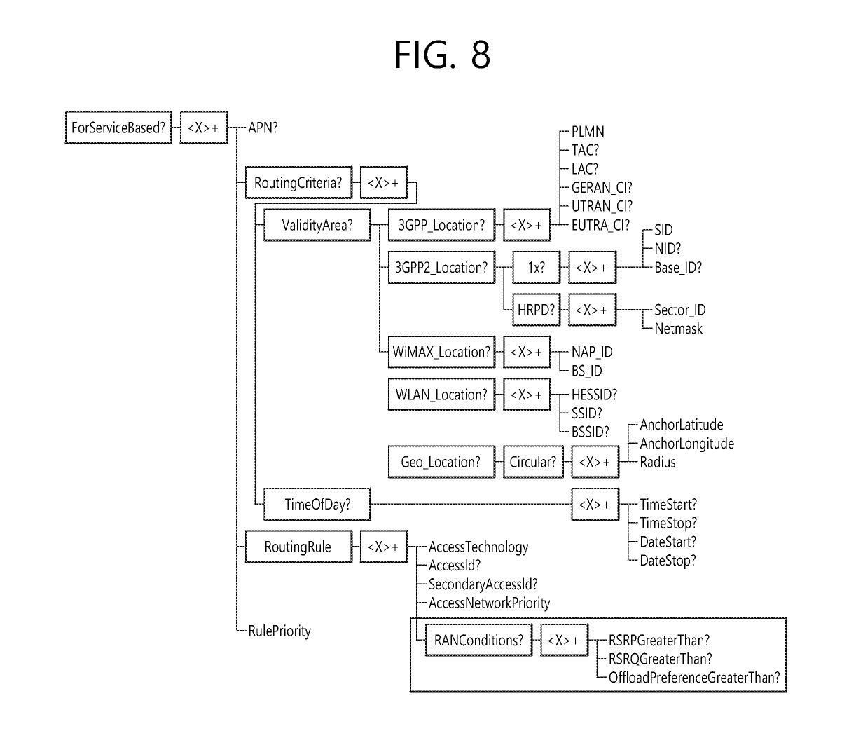

FIG. 7 shows an example of a legacy ANDSF with respect to an MAPCON, and FIG. 8 shows an example of an enhanced ANDSF with respect to the MAPCON.

Referring to FIG. 7, the legacy ANDSF does not include an RAN rule parameter such as RSRP and a WLAN signal level as an ANDSF MO.

Meanwhile, referring to FIG. 8, the enhanced ANDSF may include RSRP, RSRQ, and an offload preference as the ANDSF MO. Further, the ANDSF may include a WLAN signal level (e.g. RSSI, RSCP), a WLAN load level, a WLAN backhaul data rate, and a WLAN backhaul load.

The enhanced ANDSF may specify the traffic steering evaluation condition associated with each ANDSF MO. The traffic steering evaluation condition specified by the enhanced ANDSF may be configured similar to the traffic steering evaluation condition associated with the configured RAN rule parameter configured by the RAN rule. A detailed description thereof will be omitted.

Hereinafter, WLAN Measurement is Described.

A UE supporting LTE-WLAN aggregation (LWA) may be set by an E-UTRAN to perform WLAN measurement. A WLAN measurement object may be set using a WLAN identifier (BSS ID, HESS ID or SS ID), a WLAN channel number, and a WLAN band. A WLAN measurement report may be triggered using an RSSI. The WLAN measurement report may include an RSSI, channel utilization, a station count, admission capacity, a backhaul rate, and a WLAN identifier. WLAN measurement may be set to support at least one of LWA activation, inter WLAN mobility set mobility, and LWA deactivation.

The UE may perform WLAN mobility in an AP group without LTE control. Thus, the UE may not need to report the WLAN measurement result of an AP belonging to the same group as a currently associated AP. In order to avoid unnecessary measurement reporting, a new reporting criterion may be required. Hereinafter, a method for a UE to determine whether to report a WLAN measurement result and a device supporting the same will be described in detail according to one embodiment of the present invention.

1. UE Receives WLAN Measurement Configuration from BS

In WLAN measurement, a measurement object may be a single WLAN AP or a WLAN AP group. WLAN AP groups may be classified into a group including a serving WLAN AP and a group including no serving WLAN AP. A serving WLAN AP may refer to an AP associated with a UE. In this specification, a group including a serving WLAN AP may be referred to as a serving WLAN AP group. Alternatively, a group including a serving AP may be referred to as a WLAN mobility set. An AP group flag may be signaled to a UE per measurement object so that the UE recognizes whether a set measurement object is a single WLAN AP or a WLAN AP group. For example, when the AP group flag is ‘1’, a corresponding measurement object may be a WLAN AP group; and when the AP group flag is ‘0’, a corresponding measurement object may be a single WLAN AP. Alternatively, when the AP group flag is ‘0’, a corresponding measurement object may be a WLAN AP group; and when the AP group flag is ‘1’, a corresponding measurement object may be a single WLAN AP. When a measurement object includes a plurality of WLAN APs, the UE may obtain a corresponding member AP list from a network. The UE may obtain the member AP list through dedicated RRC_signaling or system information. Alternatively, the UE may obtain the member AP list from a higher layer (for example, from an MME through NAS signaling). Preferably, the AP group may include a single WLAN AP.

2. UE Performs WLAN Measurement

The UE may perform WLAN measurement on all APs belonging to a WLAN AP group. The WLAN AP group may be a WLAN AP group set as a measurement object by a BS.

3. UE Determines Whether to Report WLAN Measurement Result

When a WLAN reporting condition is satisfied for a WLAN AP not belonging to the same group as a serving WLAN AP, the UE may report the WLAN measurement result to the network. An AP group ID may be reported along with the measurement result of the WLAN AP. When the WLAN reporting condition is satisfied for a WLAN AP belonging to the same group as the serving WLAN AP, the UE may not report the WLAN measurement result.

The WLAN reporting condition may be a condition for triggering a measurement report on WLAN measurement. For example, the WLAN reporting condition may be that the measurement result of a neighboring WLAN AP is better than the result of applying an offset to the measurement result of the serving WLAN AP ((Neighboring WLAN AP becomes offset better than serving WLAN AP). Alternatively, the WLAN reporting condition may be that the measurement result of a neighboring WLAN AP is better than a threshold (Neighboring WLAN AP becomes better than threshold). Also, the WLAN reporting condition may be that the measurement result of the serving WLAN AP is worse than a first threshold and the measurement result of a neighboring WLAN AP is better than a second threshold (Serving WLAN AP becomes worse than threshold 1 and neighboring WLAN AP becomes better than threshold 2). Hereinafter, an example of an event-trigger condition for reporting a WLAN measurement result will be described.

(1) Event D1: The measurement result of a neighboring WLAN AP not belonging to the serving WLAN AP group is better than the result of applying an offset to the measurement result of the serving WLAN AP (Neighboring WLAN AP which does not belong to serving WLAN AP group becomes offset better than serving WLAN AP).

When an entering condition of event D1 is satisfied, the UE may report the WLAN measurement result to the network. On the other hand, when a leaving condition of event D1 is satisfied, the UE may stop reporting the WLAN measurement result. Further, when the leaving condition of event D1 is satisfied and the timer is operating, the UE may stop a corresponding periodic report timer.

For example, the entering condition and the leaving condition of event D1 may be defined as follows.

Event D1-1 entering condition: Mn+Ofn+Oan+Ogn−Hys>Ms+Ofs+Oas+Ogs+Off

Event D1-2 leaving condition: Mn+Ofn+Oan+Ogn+Hys<Ms+Ofs+Oas+Ogs+Off

Mn may be the measurement result of a neighboring WLAN AP not belonging to the serving WLAN AP group. Ms may be the measurement result of the serving WLAN AP. Alternatively, Ms may be the measurement result of all WLAN APs belonging to the serving WLAN AP group. Ofn may be a frequency-specific (or WLAN channel-specific) offset for a neighboring WLAN AP frequency. Ofs may be a frequency-specific offset for a serving WLAN AP frequency. Oan may be a WLAN AP-specific offset for the neighboring WLAN AP and may be 0 if not set for the neighboring WLAN AP. Oas may be a WLAN AP-specific offset for the serving WLAN AP and may be 0 if not set for the serving WLAN AP. Ogn may be a WLAN AP group-specific offset for the neighboring WLAN AP. Ogs may be a WLAN AP group-specific offset for the serving WLAN AP. Hys may be a hysteresis parameter for event D1. Off may be an offset parameter for event D1.

(2) Event D2: The measurement result of a neighboring WLAN AP not belonging to the serving WLAN AP group is better than the result of applying an offset to the measurement result of the strongest WLAN AP belonging to the serving WLAN AP group (Neighboring WLAN AP which does not belong to serving WLAN AP group becomes offset better than strongest WLAN AP within serving WLAN AP group).

When an entering condition of event D2 is satisfied, the UE may report the WLAN measurement result to the network. On the other hand, when a leaving condition of event D2 is satisfied, the UE may stop reporting the WLAN measurement result. Further, when the leaving condition of event D2 is satisfied and the timer is operating, the UE may stop a corresponding periodic report timer.

For example, the entering condition and the leaving condition of event D2 may be defined as follows.

Event D2-1 Even: Mn+Ofn+Oan+Ogn−Hys>Mss+Ofss+Oass+Ogs+Off

Event D2-2 leaving condition: Mn+Ofn+Oan+Ogn+Hys<Mss+Ofss+Oass+Ogs+Off

Mn may be the measurement result of a neighboring WLAN AP not belonging to the serving WLAN AP group. Mss may be the measurement result of the strongest WLAN AP belonging to the serving WLAN AP group. Ofn may be a frequency-specific (or WLAN channel-specific) offset for a neighboring WLAN AP frequency. Ofss may be a frequency-specific offset for a frequency for the strongest WLAN AP belonging to the serving WLAN AP group. Oan may be a WLAN AP-specific offset for the neighboring WLAN AP and may be 0 if not set for the neighboring WLAN AP. Oas may be a WLAN AP-specific offset for the serving WLAN AP and may be 0 if not set for the strongest WLAN AP belonging to the serving WLAN AP group. Ogn may be a WLAN AP group-specific offset for the neighboring WLAN AP. Ogs may be a WLAN AP group-specific offset for the serving WLAN AP. Hys may be a hysteresis parameter for event D2. Off may be an offset parameter for event D2.

(3) Event D3: The measurement result of a neighboring WLAN AP not belonging to the serving WLAN AP group is better than a threshold (Neighboring WLAN AP which does not belong to serving WLAN AP group becomes better than threshold).

When an entering condition of event D3 is satisfied, the UE may report the WLAN measurement result to the network. On the other hand, when a leaving condition of event D3 is satisfied, the UE may stop reporting the WLAN measurement result. Further, when the leaving condition of event D3 is satisfied and the timer is operating, the UE may stop a corresponding periodic report timer.

For example, the entering condition and the leaving condition of event D3 may be defined as follows.

Event D3-1 entering condition: Mn+Ofn+Oan+Ogn−Hys>Thresh

Event D3-2 leaving condition: Mn+Ofn+Oan+Ogn+Hys<Thresh

Mn may be the measurement result of a neighboring WLAN AP not belonging to the serving WLAN AP group. Ofn may be a frequency-specific (or WLAN channel-specific) offset for a neighboring WLAN AP frequency. Oan may be a WLAN AP-specific offset for the neighboring WLAN AP and may be 0 if not set for the neighboring WLAN AP. Ogn may be a WLAN AP group-specific offset for the neighboring WLAN AP. Hys may be a hysteresis parameter for event De. Thresh may be a threshold parameter for event D 3.

(4) Event D4: The measurement result of the serving WLAN AP is worse than a first threshold and the measurement result of a neighboring WLAN AP not belonging to the serving WLAN AP group is better than a second threshold (Serving WLAN AP becomes worse than threshold 1 and neighboring WLAN AP not belonging to serving WLAN AP group becomes better than threshold 2).

When an entering condition of event D4 is satisfied, the UE may report the WLAN measurement result to the network. On the other hand, when a leaving condition of event D4 is satisfied, the UE may stop reporting the WLAN measurement result. Further, when the leaving condition of event D 4 is satisfied and the timer is operating, the UE may stop a corresponding periodic report timer.

For example, the entering condition and the leaving condition of event D4 may be defined as follows.

Event D4-1 entering condition: Ms+Hys<Thresh1

Event D4-2 entering condition: Mn+Ofn+Oan+Ogn−Hys>Thresh2

Event D4-3 leaving condition: Ms−Hys>Thresh1

Event D4-4 leaving condition: Mn+Ofn+Oan+Ogn+Hys<Thresh2

Alternatively, the entering condition and the leaving condition of event D4 may be defined as follows.

Event D4-1 entering condition: Ms+Hys<Thresh1

Event D4-2 entering condition: Mn−Hys>Thresh2

Event D4-3 leaving condition: Ms−Hys>Thresh1

Event D4-4 leaving condition: Mn+Hys<Thresh2

Mn may be the measurement result of a neighboring WLAN AP not belonging to the serving WLAN AP group. Ms may be the measurement result of the serving WLAN AP. Alternatively, Ms may be the measurement result of all WLAN APs belonging to the serving WLAN AP group. Ofn may be a frequency-specific (or WLAN channel-specific) offset for a neighboring WLAN AP frequency. Oan may be a WLAN AP-specific offset for the neighboring WLAN AP and may be 0 if not set for the neighboring WLAN AP. Ogn may be a WLAN AP group-specific offset for the neighboring WLAN AP. Hys may be a hysteresis parameter for event D4. Thresh1 may be a threshold parameter for event D4. Thresh2 may be a threshold parameter for event D4.

When both the event D4-1 entering condition and the event D4-2 entering condition are satisfied, the UE may report the WLAN measurement result to the network. When at least one of the event D4-3 leaving condition and the event D4-4 leaving condition is satisfied, the UE may stop reporting the WLAN measurement result.

A measurement index of a WLAN measurement (for example, Ms or Mn) may be at least one of a WLAN beacon RSSI, channel utilization in BSS load, an uplink backhaul rate, a downlink backhaul rate, a station count, and available admission.

The UE may obtain explicit WLAN AP group information from the network, thereby identifying a group to which a WLAN AP belongs. The WLAN AP group information may be a group ID or a member AP list. Alternatively, the UE may consider WLAN APs having the same homogeneous extended service set identifier (HESSID) to belong to the same WLAN AP group and may consider WLAN APs having different HESSIDs to belong to different WLAN AP groups. Alternatively, the UE may consider WLAN APs having the same service set identifier (SSID) to belong to the same WLAN AP group and may consider WLAN APs having different SSIDs to belong to different WLAN AP groups.

4. UE Receives AP Handover Command

The UE may receive an AP handover command message from the BS. The AP handover command message may be a message indicating an instruction to change the serving WLAN AP.

(1) When the AP Handover Command Message Includes the ID of One Target AP

When the target WLAN AP belongs to the serving WLAN AP group, the UE may ignore an AP change command. When the target WLAN AP does not belong to the serving WLAN AP group, the UE may perform an AP handover procedure according to the AP handover command message.

(2) When the AP Handover Command Message Includes the IDs of a Plurality of Target APs

When the target WLAN APs belong to the serving WLAN AP group, the UE may ignore an AP change command. When some of the target WLAN APs indicated by the AP handover command message do not belong to the serving WLAN AP group, the UE may select one of the target WLAN APs not belonging to the serving WLAN AP group may perform a procedure for handover to the selected target WLAN AP.

(3) When the AP handover command message includes the ID of a target AP group

When the target WLAN AP group is a currently serving WLAN AP group, the UE may ignore an AP change command. When the target WLAN AP group is not a currently serving WLAN AP group, the UE may perform an AP handover procedure according to the AP handover command message.

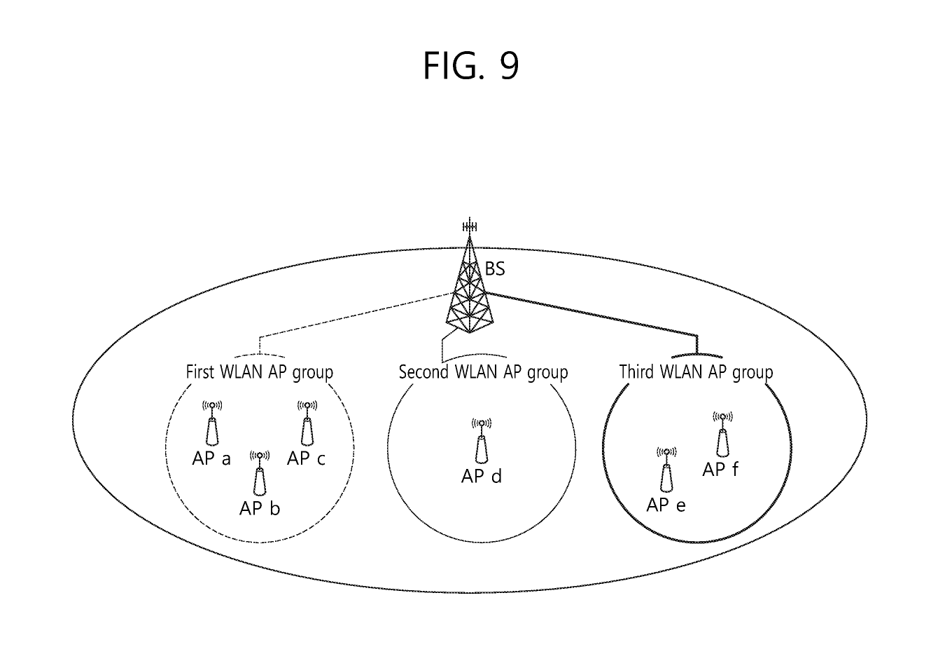

FIG. 9 illustrates one example of a method for a UE to determine whether to report a WLAN measurement result according to one embodiment of the present invention.

Referring to FIG. 9, there are three WLAN AP groups within the coverage of a BS. It is assumed that AP a, AP b, and AP c are included in a first WLAN AP group, AP d is included in a second WLAN AP group, and AP e and AP f are included in a third WLAN AP group.

(1) A UE may receive two measurement configurations for WLAN measurement. For example, the two measurement configurations may relate to the first WLAN AP group and AP d.

(2) The UE may receive a WLAN measurement associated with system information from a serving cell and may obtain a list of APs belonging to the first WLAN AP group.

(3) The UE may perform WLAN measurements on AP a, AP b, AP c, and AP d.

(4) Assume that the measurement result of AP b satisfies an entering condition of a particular event. Therefore, the UE may report the measurement result of AP b to a network. The ID of the first WLAN AP group may be reported together with the measurement result of AP b.

(5) The UE may receive an LTE/WLAN aggregation command from the BS and may establish a connection with AP b. AP b can become a serving WLAN AP for the UE. The UE may maintain performing WLAN measurement on AP a, AP b, AP c, and AP d.

(6) Assume that the measurement result of AP c satisfies the entering condition of the particular event. However, since AP c belongs to the same group as the serving WLAN AP, the UE may not report the measurement result of AP c to the BS.

(7) Assume that the measurement result of AP d satisfies the entering condition of the particular event. Since AP d belongs to a different group from the serving WLAN AP, the UE may report the measurement result of AP d to the BS.

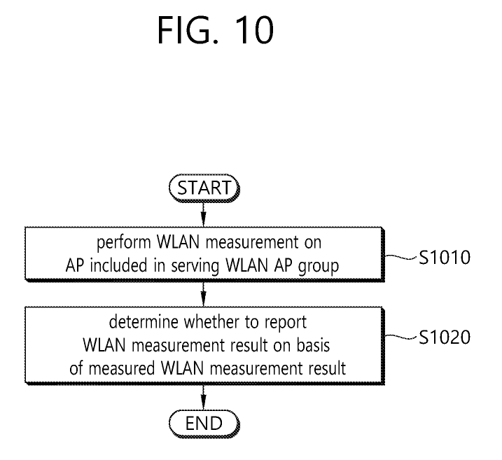

FIG. 10 is a block diagram illustrating a method for a UE to determine whether to report a WLAN measurement result according to one embodiment of the present invention.

Referring to FIG. 10, the UE may perform WLAN measurement on an AP belonging to a serving WLAN AP group (S1010).

The UE may determine whether to report a WLAN measurement result based on the result of the performed WLAN measurement (S1020).

When a value obtained by applying a hysteresis to the WLAN measurement result is less than a threshold, it may be determined to report the WLAN measurement result. For example, when ‘Ms+Hys<Thresh’, it may be determined to report the WLAN measurement result. Therefore, the UE may report the WLAN measurement result. When a value obtained by applying the hysteresis to the WLAN measurement result is greater than the threshold, the UE may stop reporting the WLAN measurement result. For example, when ‘Ms-Hys>Thresh’, the UE may stop reporting the WLAN measurement result. The WLAN measurement may be performed on a serving AP among APs belonging to the serving WLAN AP group. Alternatively, the WLAN measurement may be performed on all APs belonging to the serving WLAN AP group.

The UE may perform WLAN measurement on an AP not belonging to the serving WLAN AP group.

When a value obtained by applying a hysteresis to the WLAN measurement result of the AP belonging to the serving WLAN AP group is less than a first threshold and a value obtained by applying the hysteresis to the WLAN measurement result of the AP not belonging to the serving WLAN AP group is greater a second threshold, it may be determined to report the result of the WLAN measurement. For example, when ‘Ms+Hys<Thresh1’ and ‘Mn−Hys>Thresh2’, it may be determined to report the result of the WLAN measurement. For example, if ‘Ms+Hys<Thresh1’ and ‘Mn+Ofn+Oan+Ogn−Hys>Thresh2’, it may be determined to report the result of the WLAN measurement. Therefore, the UE may report the WLAN measurement result. When a value obtained by applying the hysteresis to the WLAN measurement result of the AP belonging to the serving WLAN AP group is greater than the first threshold or a value obtained by applying the hysteresis to the WLAN measurement result of the AP not belonging to the serving WLAN AP group is less than the second threshold, the UE may stop reporting the WLAN measurement result. For example, when ‘Ms−Hys>Thresh1’ or ‘Mn+Hys<Thresh2’, the UE may stop reporting the WLAN measurement result. For example, when ‘Ms−Hys>Thresh1’ or ‘Mn+Ofn+Oan+Ogn+Hys<Thresh2’, the UE may stop reporting the WLAN measurement result. The AP belonging to the serving WLAN AP group may be a serving AP serving the UE among the APs belonging to the serving WLAN AP group. Alternatively, the AP belonging to the serving WLAN AP group may be all APs belonging to the serving WLAN AP group. The serving WLAN AP group may be a WLAN mobility set.

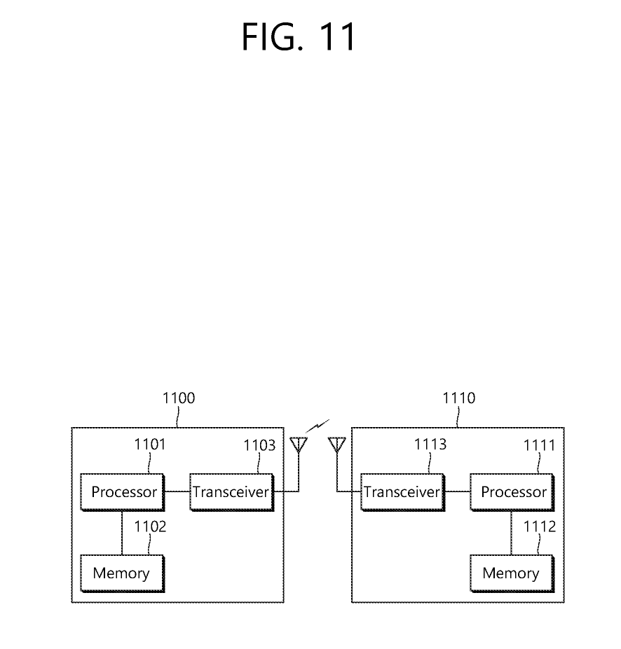

FIG. 11 is a block diagram illustrating a wireless communication system according to the embodiment of the present invention.

ABS 1100 includes a processor 1101, a memory 1102 and a transceiver 1103. The memory 1102 is connected to the processor 1101, and stores various pieces of information for driving the processor 1101. The transceiver 1103 is connected to the processor 1101, and transmits and/or receives radio signals. The processor 1101 implements proposed functions, processes and/or methods. In the above embodiment, an operation of the base station may be implemented by the processor 1101.

A UE 1110 includes a processor 1111, a memory 1112 and a transceiver 1113. The memory 1112 is connected to the processor 1111, and stores various pieces of information for driving the processor 1111. The transceiver 1113 is connected to the processor 1111, and transmits and/or receives radio signals. The processor 1111 implements proposed functions, processes and/or methods. In the above embodiment, an operation of the UE may be implemented by the processor 1111.

The processor may include an application-specific integrated circuit (ASIC), a separate chipset, a logic circuit, and/or a data processing unit. The memory may include a read-only memory (ROM), a random access memory (RAM), a flash memory, a memory card, a storage medium, and/or other equivalent storage devices. The transceiver may include a base-band circuit for processing a wireless signal. When the embodiment is implemented in software, the aforementioned methods can be implemented with a module (i.e., process, function, etc.) for performing the aforementioned functions. The module may be stored in the memory and may be performed by the processor. The memory may be located inside or outside the processor, and may be coupled to the processor by using various well-known means.

Various methods based on the present specification have been described by referring to drawings and reference numerals given in the drawings on the basis of the aforementioned examples. Although each method describes multiple steps or blocks in a specific order for convenience of explanation, the invention disclosed in the claims is not limited to the order of the steps or blocks, and each step or block can be implemented in a different order, or can be performed simultaneously with other steps or blocks. In addition, those ordinarily skilled in the art can know that the invention is not limited to each of the steps or blocks, and at least one different step can be added or deleted without departing from the scope and spirit of the invention.

The aforementioned embodiment includes various examples. It should be noted that those ordinarily skilled in the art know that all possible combinations of examples cannot be explained, and also know that various combinations can be derived from the technique of the present specification. Therefore, the protection scope of the invention should be determined by combining various examples described in the detailed explanation, without departing from the scope of the following claims.

What is claimed is:

1. A method for determining, by a user equipment (UE), whether to report a wireless local area network (WLAN) measurement result in a wireless communication system, the method comprising:
performing WLAN measurement on an access point (AP) belonging to a serving WLAN AP group; and
determining whether to report a WLAN measurement result based on a result of the performed WLAN measurement.

2. The method of claim 1, wherein when a value obtained by applying a hysteresis to the WLAN measurement result is less than a threshold, it is determined to report the WLAN measurement result.

3. The method of claim 2, further comprising reporting, by the UE, the WLAN measurement result.

4. The method of claim 3, further comprising stopping, by the UE, reporting the WLAN measurement result when a value obtained by applying the hysteresis to the WLAN measurement result is greater than the threshold.

5. The method of claim 4, wherein the WLAN measurement is performed on a serving AP among APs belonging to the serving WLAN AP group.

6. The method of claim 4, wherein the WLAN measurement is performed on all APs belonging to the serving WLAN AP group.

7. The method of claim 1, further comprising performing, by the UE, WLAN measurement on an AP not belonging to the serving WLAN AP group.

8. The method of claim 7, wherein when a value obtained by applying a hysteresis to the WLAN measurement result of the AP belonging to the serving WLAN AP group is less than a first threshold and a value obtained by applying the hysteresis to a WLAN measurement result of the AP not belonging to the serving WLAN AP group is greater a second threshold, it is determined to report the WLAN measurement result.

9. The method of claim 8, further comprising reporting, by the UE, the WLAN measurement result.

10. The method of claim 9, further comprising stopping, by the UE, reporting the WLAN measurement result when a value obtained by applying the hysteresis to the WLAN measurement result of the AP belonging to the serving WLAN AP group is greater than the first threshold or a value obtained by applying the hysteresis to the WLAN measurement result of the AP not belonging to the serving WLAN AP group is less than the second threshold.

11. The method of claim 10, wherein the AP belonging to the serving WLAN AP group is a serving AP serving the UE among APs belonging to the serving WLAN AP group.

12. The method of claim 10, wherein the AP belonging to the serving WLAN AP group is all APs belonging to the serving WLAN AP group.

13. The method of claim 12, wherein the serving WLAN AP group is a WLAN mobility set.

14. A user equipment (UE) for determining whether to report a wireless local area network (WLAN) measurement result in a wireless communication system, the UE comprising:
a memory;
a transceiver; and
a processor to connect the memory and the transceiver,
wherein the processor is configured to: perform WLAN measurement on an access point (AP) belonging to a serving WLAN AP group; and determine whether to report a WLAN measurement result based on a result of the performed WLAN measurement.

15. The UE of claim 14, wherein the processor is configured to perform WLAN measurement on an AP not belonging to the serving WLAN AP group.
